(19) United States
(12) Patent Application Publication
(10) Pub. No.: US 2021/0081265 A1
(43) Pub. Date: Mar. 18, 2021

(54) INTELLIGENT CLUSTER AUTO-SCALER

(71) Applicant: International Business Machines Corporation, Armonk, NY (US)

(72) Inventors: Natesh H Mariyappa, Bangalore (IN); Mohammed Omar, Hyderabad (IN); Raghavendra Rao Dhayapule, Bangalore (IN)

(21) Appl. No.: 16/568,979

(22) Filed: Sep. 12, 2019

(51) Int. Cl. G06F 11/07; G06N 20/00; G06F 9/38; G06F 9/50

(52) U.S. Cl. CPC G06F 11/079; G06F 9/5072; G06F 9/3891; G06N 20/00

(57) ABSTRACT

A method, system, and computer program product to develop intelligent auto-scalers to determine root causes of applications running on a cluster, where the method may include identifying one or more resource problems within a cluster. The method may also include identifying one or more problematic pods that have the one or more resource problems. The method may also include analyzing the one or more resource problems. The method may also include determining an actual root cause of the one or more problematic pods based on the analyzing. Determining the actual root cause may include analyzing data collected from multiple data sources, where the multiple data sources include at least one of: logs, an RCA database, and investigation of resources. The method may also include determining a fix method for the actual root cause. The method may also include applying the fix method to the one or more problematic pods.

### BACKGROUND

The present disclosure relates to cluster auto scaling, and more specifically to developing intelligent auto-scalers to determine root causes of applications running on a cluster.

### SUMMARY

The present disclosure provides a computer-implemented method, system, and computer program product to develop intelligent auto-scalers to determine root causes of applications running on a cluster. According to an embodiment of the present invention, the method may include identifying one or more resource problems within a cluster. The method may also include identifying one or more problematic pods that have the one or more resource problems. The method may also include analyzing the one or more resource problems. The method may also include determining an actual root cause of the one or more problematic pods based on the analyzing. Determining the actual root cause may include analyzing data collected from multiple data sources, where the multiple data sources include at least one of: logs, an RCA database, and investigation of resources. The method may also include determining a fix method for the actual root cause. The method may also include applying the fix method to the one or more problematic pods.

The system may have one or more computer processors and may be configured to identify one or more resource problems within a cluster. The system may also be configured to identify one or more problematic pods that have the one or more resource problems. The system may also be configured to analyze the one or more resource problems. The system may also be configured to determine an actual root cause of the one or more problematic pods based on the analyzing. Determining the actual root cause may include analyzing data collected from multiple data sources, where the multiple data sources include at least one of: logs, an RCA database, and investigation of resources. The system may also be configured to determine a fix method for the actual root cause. The system may also be configured to apply the fix method to the one or more problematic pods.

The computer program product may include a computer readable storage medium having program instructions embodied therewith, the program instructions executable by a server to cause the server to perform a method. The method may include identifying one or more resource problems within a cluster. The method may also include identifying one or more problematic pods that have the one or more resource problems. The method may also include analyzing the one or more resource problems. The method may also include determining an actual root cause of the one or more problematic pods based on the analyzing. Determining the actual root cause may include analyzing data collected from multiple data sources, where the multiple data sources include at least one of: logs, an RCA database, and investigation of resources. The method may also include determining a fix method for the actual root cause. The method may also include applying the fix method to the one or more problematic pods.

### BRIEF DESCRIPTION OF THE DRAWINGS

FIG. 1 depicts a flowchart of a set of operations for determining a root cause of problematic pods running on a nodes, according to some embodiments.

FIG. 2 depicts a flowchart of a set of operations for predicting a root cause of problematic pods, according to some embodiments.

FIG. 3 depicts a schematic diagram of an example cluster of nodes, according to some embodiments.

FIG. 4 depicts a block diagram of a sample computer system, according to some embodiments.

FIG. 5 depicts a cloud computing environment, according to some embodiments.

FIG. 6 depicts abstraction model layers, according to some embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present disclosure relates to cluster auto scaling, and more specifically to developing intelligent auto-scalers to determine root causes of applications running on a cluster. While the present disclosure is not necessarily limited to such applications, various aspects of the disclosure may be appreciated through a discussion of various examples using this context.

In cloud computing, an application may be running on a cluster and may need to be scaled based on the resources available when metrics-related problems arise. Metrics may refer to the available resources being used. A cluster is a type of hardware that may consist of a multi-pod and multi-node environment. A pod is a type of software that may consist of one or more containers. A pod may be assigned to run on a node, and a node may have one or more pods running on it. A node is a unit of computing hardware where one or more nodes may form a cluster. An auto-scaler may automatically scale resources to meet network traffic requirements and may be used in multi-cloud traffic management either privately or publicly.

In some embodiments, an auto-scaler may mechanically scale the number of pods or nodes based on the number of resources used or available. These resources may be based on metrics including, but not limited to, CPU utilization, memory utilization, or application-provided custom metrics. Conventional auto-scalers may automatically scale the pods or nodes by increasing or decreasing the number of pods and nodes based only on the available resources. This may lead to inaccurate auto-scaling, as such mechanical auto-scaling may not consider factors such as the behavior, design, or internals of the application running on top of the pods in a cluster. For example, if there are insufficient resources available to place pods, then extra nodes may be added by the auto-scaler. In another example, if the nodes are underutilized, then the auto-scaler may release such nodes and moves the pods running on such nodes to other available nodes in the cluster. This non-intelligent mechanical auto-scaling may lead to improper resource allocation or unnecessary pod quantity adjustments and may further result in application problems such as slowed performance or failed responses.

The present disclosure provides a computer-implemented method, system, and computer program product to develop intelligent auto-scalers that correlate collected metrics of an application running on a cluster with identified performance issues and determine their root cause(s). In some embodiments, it may be beneficial for intelligent auto-scalers to consider the behavior, design, and internals of an application running on top of the pods in a cluster. This intelligent auto-scaler may then be able to a fix problem at its source instead of fixing the consequences of the resource problem. For example, the intelligent auto-scaler may fix the cause of a memory leak instead of merely adding extra memory to compensate for the memory leak. The intelligent auto-scaler may also use past behavior and past metrics maintained in a database to compare to current behavior and live metrics to predict resource problems and attempt auto-fix methods.

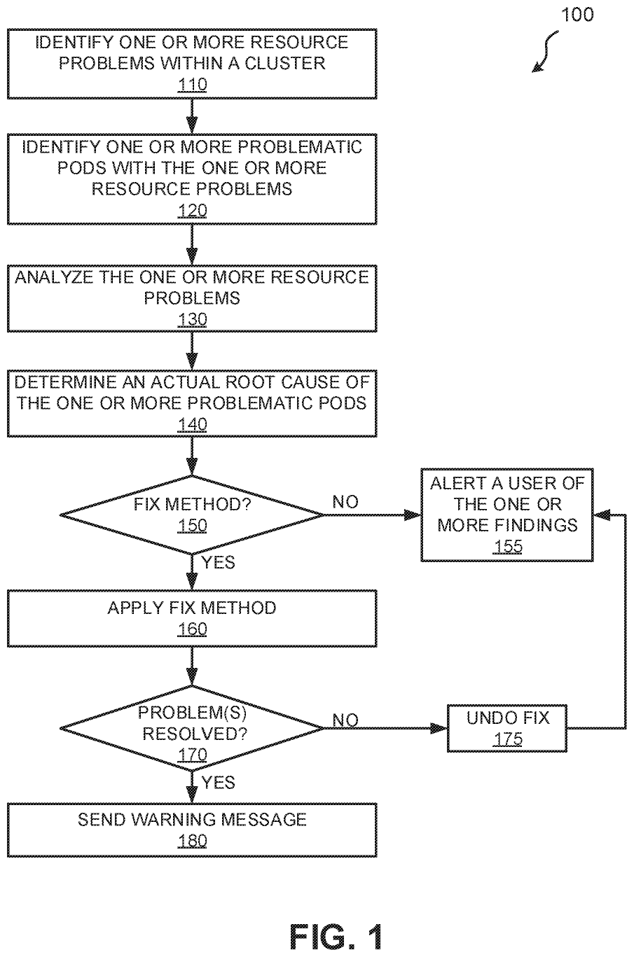

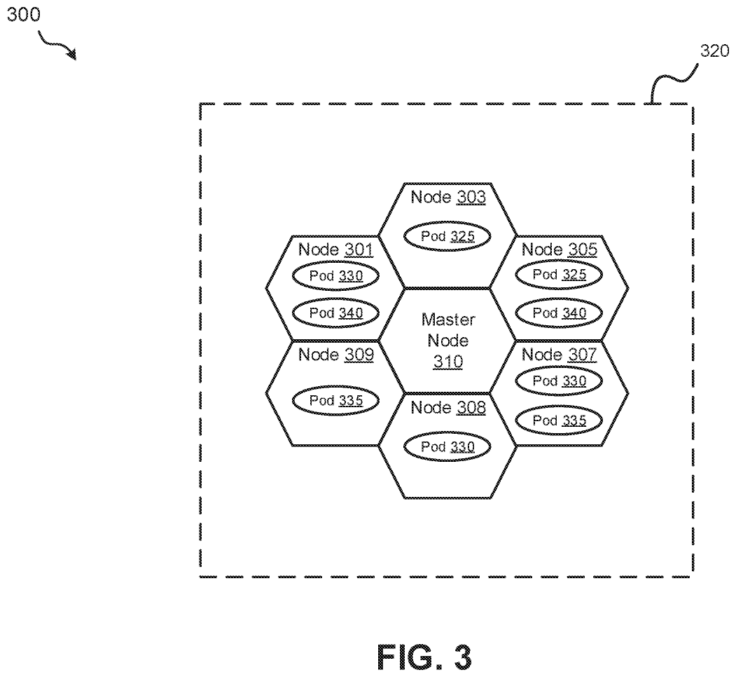

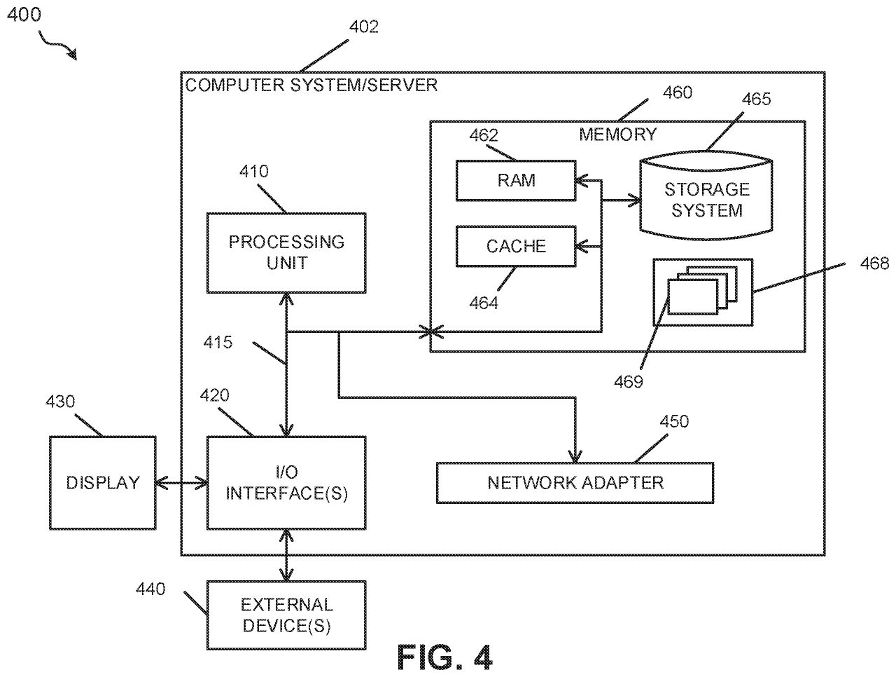

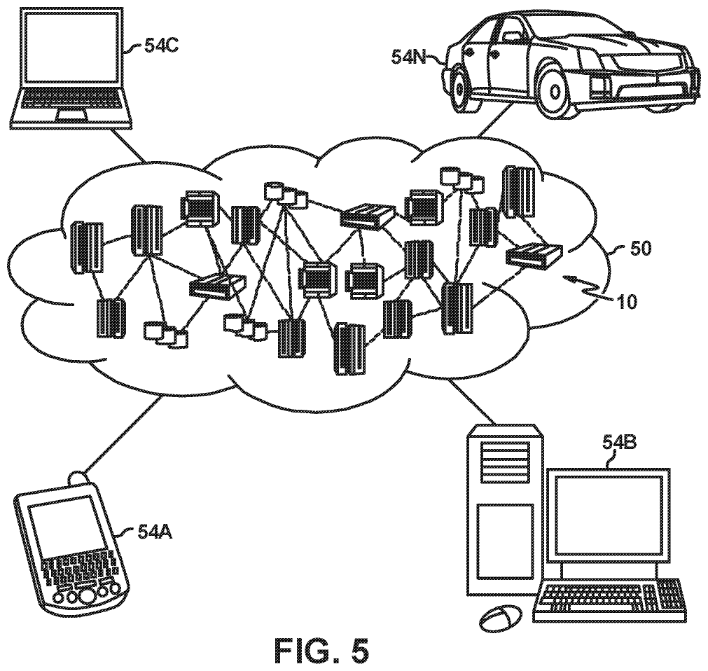

Referring now to FIG. 1, a flowchart illustrating a method 100 for determining a root cause of problematic pods running on nodes is depicted, according to some embodiments. In some embodiments, the method 100 is implemented as a computer script or computer program (e.g., computer executable code) to be executed by a server on or connected to a computer system (e.g., computer system 400 (FIG. 4)). In some embodiments, the server is a computer device, such as a computer system/server 402 (FIG. 4). In some embodiments, the method 100 is executed by a node, such as a master node (e.g., master node 310 (FIG. 3)) within a cluster (e.g., cluster 320 (FIG. 3)) and/or a node (e.g., computing nodes 10 (FIG. 5)) within a cloud computing environment (e.g., cloud computing environment 50 (FIG. 5)).

Method 100 includes operation 110 to identify one or more resource problems within a cluster. Resource problems may be issues with the resources (e.g., memory, processor/CPU, disk, video card, hard drive, etc.) used by the pods. In some instances, there may be insufficient resources (i.e., not enough resources) to execute certain actions (e.g., to place pods, to run an application (or an instance of an application), run a pod, etc. For example, an application may have a memory leak, which may result in insufficient memory for the pods and/or nodes. In this example, the memory leak may be a resource problem.

In some embodiments, resource problems may be found by using a machine learning algorithm to collect node levels, container levels, and application related metrics to examine resource utilization and determine any outlier behavior when compared to usual behavior.

Method 100 includes operation 120 to identify one or more problematic pods.

Problematic pods may be pods having, or causing, the one or more resource problems. Once it is determined that there is a resource problem, it may be determined which pods are causing the resource problem. For example, a newly launched pod may be excessively consuming all the available resources within a node, and across a cluster of nodes. In this example, the lack of available resources for other pods within the nodes may be the resource problem, and the newly launched pod may be the problematic pod.

In some embodiments, identifying the one or more problematic pods includes flagging the one or more problematic pods for a user. Flagging the problematic pods may include transmitting an alert to a user indicating the pods that are problematic. In some embodiments, flagging the problematic pods includes marking the problematic pods.

Method 100 includes operation 130 to analyze the one or more resource problems. The one or more resource problems may be analyzed by determining one or more metrics problems. More specifically, in some embodiments, analyzing the one or more resource problems may include analyzing one or more resources used for one or more pods within the cluster (e.g., one or more of pods 325, 330, 335, and 340 within cluster 320 (FIG. 3)) and identifying one or more metrics problems for at least one of the resources. In some embodiments, the intelligent auto-scaler may determine the one or more metrics problems by continuously monitoring and collecting metrics from multiple sources. The intelligent auto-scaler may have access to all the pods in a worker node and may know how many pods are running for an app at any given instance. The intelligent auto-scaler may also have access to all worker nodes and may know how many worker nodes are present and may also know how many pods are running in each worker node. In some embodiments, the intelligent auto-scaler is deployed on a master node within the cluster (e.g., master node 310 (FIG. 3)).

Method 100 includes operation 140 to determine an actual root cause of the one or more problematic pods. In some embodiments, determining the actual root cause is based on analyzing the one or more resource problems (operation 130). When determining the actual root cause of the one or more problematic pods, one or more predicted root causes may be predicted for the one or more resource problems. In other words, determining the actual root cause of the problematic pods may include predicting the root cause of the one or more resource problems. Determining the one or more predicted root causes may include collecting past metrics from a first time period by retrieving one or more application metrics and receiving one or more dependent services metrics. Next, a machine learning algorithm may then be built based on the past metrics. Then, current metrics may be collected where the current metrics are metrics from a current time period, the current time period subsequent to the first time period. Next, the machine learning algorithm may be trained based on the past metrics and current metrics. Then, the one or more predicted root causes may be determined based on the past metrics and the current metrics. Lastly, the one or more predicted root causes may be added to the machine learning algorithm.

Over time, the machine learning algorithm may read a live feed, which may include a live feed of the current data (e.g., relating to the current metrics), and may also include tuples containing the past data (e.g., relating to the past metrics), and the machine learning algorithm may predict resource problems using the tuple containing the past data and the live feed of the current data. When one or more resource problems arise, the machine learning algorithm may use past training to apply an attempted fix method and send alerts to the user based on the type of fix attempted. If the one or more resource problems are not resolved, the attempted fix method may be undone and the user may be notified with all the details. A training set may be built and may maintain all of the collected metrics for the application and the dependent services. For the training set, a data structure may be maintained to map the actual root cause, the predicted root cause, and the training set files. If the actual root cause is determined to be different than the one or more predicted root causes, the one or more predicted root causes may be overridden, and the machine learning algorithm may be retrained using the aforementioned training set. If neither the actual root cause or the one or more predicted root cause is found in the machine learning algorithm or the training set, then it may be added to the training set to train the machine learning algorithm.

The actual root cause for the one or more resource problems may be determined using multiple data sources including, but not limited to, logs from a logstore using log analysis, the root cause analysis database, the predicted root cause, the analysis of monitoring the collected metrics, and actual investigation. The root cause analysis database may be comprised of a collection of remediation processes from past resource problems that may be referred to for the current one or more resource problems. If the actual root cause is different from the one or more predicted root causes, the machine learning algorithm may be trained with the actual root cause based on the past metrics and the current metrics.

In some embodiments, method 100 may include transmitting the results of the determining the actual root cause to a user. This may be beneficial, for example, if a user (e.g., a DevOps developer, etc.) needs the results for his or her records or to determine a further action. Transmitting the results to a user may include sending the results to a user interface. In some embodiments, the results include the actual root cause of the one or more problematic pods. The results may also include additional data used to determine the actual root cause.

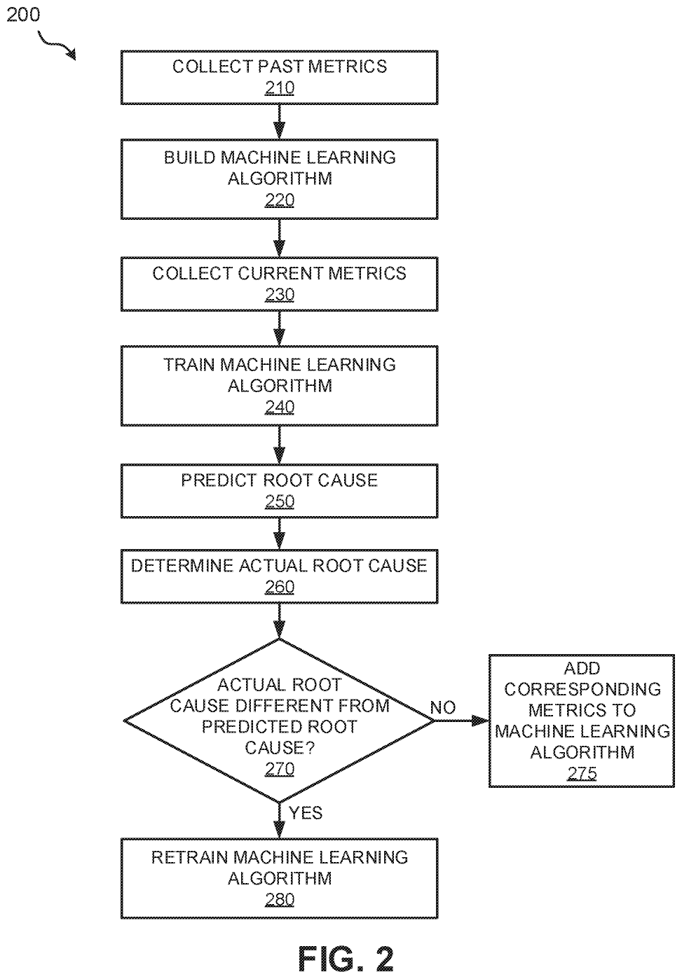

Determining the actual root cause (and the predicted root cause) is discussed further in FIG. 2.

Method 100 includes operation 150 to determine whether there is a fix method for the actual root cause. Fix methods may be methods or solutions to solve the one or more resource problems. In some embodiments, the fix method is automatically applied without any user involvement. Various root causes and their corresponding fix methods may be known by the system (e.g., the master node, etc.) in some embodiments. In some embodiments, the machine learning algorithm may be continuously trained to determine fix methods for the one or more resource problems.

Some example root causes, or error messages, and their corresponding fix methods may include:

Version check is failed—Restart the application or pod;

Environment variable ENABLE_MONITORING is not found—Add environment variable and restart application;

Environment variable SERVICE_ID is not found—report the issue to DevOps immediately;

OutOfMemory exception—increase memory and restart the pod;

IOException—check if the directory has sufficient privileges;

TimeoutException—check the network connectivity;

StackOverflowError—Increase memory and report to DevOps;

DiskOutOfSpace in/var/logs—Clean up the logs;

DiskOutOfSpace in/boot volume—add more disk space to/boot;

Cloudant Backup is failed—Retry the operation and report the issue to DevOps after multiple retries;

etc.

If it is determined, in operation 150, that there is no fix method, method 100 includes operation 155 to alert a user of the one or more findings. In some instances, a fix method may not be known by the system/server. For example, the root cause may not be a root cause known in the above list of example root causes, therefore a fix method may not be known for the specific root cause. If there is no fix method, or a fix method is not known, an alert of the one or more findings may be sent, or transmitted, to a user (e.g., through a user interface). In some embodiments, a user may manually determine a fix method for the actual root cause. The manually determined fix method, in some embodiments, may be used to train the machine learning algorithm so that a fix method may then exist for the specific actual root cause.

If it is determined, in operation 150, that there is a fix method, method 100 includes operation 160 to apply the fix method to the one or more problematic pods. In some embodiments, if a fix method exists (i.e., is known by the system) for the specific actual root cause, the fix method may be applied (e.g., automatically) to attempt to resolve the resource problems and eliminate the actual root cause. For example, if disk space is continuously increasing, the fix method(s) may include deleting old files, dynamically adding disk space, or deleting log files if the log files are consuming the disk.

Method 100 includes operation 170 to determine whether the one or more resource problems are resolved. Determining whether the one or more resource problems are resolved may include analyzing the cluster to determine if resource problems, or the specific resource problem, still exist within the cluster. In some embodiments, determining whether the one or more resource problems are resolved may include monitoring the problematic pods to determine whether the pods are still causing the one or more resource problems (e.g., consuming too many resources, leaking resources, etc.).

In some embodiments, multiple fix methods exist for an actual root cause. If multiple fix methods exist, a first fix method may be applied, and operation 170 may determine the first fix method resolved the issue. In some embodiments, if the first fix method does not resolve the issue, method 100 may return to operation 160 and apply a second fix method. This may repeat until all possible fix methods for an actual root cause have been applied, or until a fix method resolves the one or more resource problems.

If it is determined, in operation 170, that the one or more resource problems are not resolved, operation 175 rolls back the applied fix method. This may reduce the likelihood that potential other problems, or issues, are not caused by the failed fix method. In some embodiments, once the fix method has been undone, method 100 may proceed to operation 155 to alert a user of the one or more findings. If the fix method is undone, then the resource problems likely still exist within the cluster, and still may need to be resolved. Alerting the user may allow the user to manually fix the actual root cause. Operation 155 is further discussed herein.

In some embodiments, if it is determined that one or more resource problems are not resolved, a fix value may be determined, or calculated, to identify how effective the fix method is. For instance, the fix method may not have fully resolved the one or more resource problems, but the one or more resource problems may have been reduced. The fix value may be a numeric value, percentage, decimal, etc. identifying the effectiveness of the fix method. For example, a 55% fix value may demonstrate that the fix method was 55% effective. In some embodiments, the fix value may be compared with a threshold fix value and it is determined whether the fix value is greater than, or equal to, the threshold fix value. For example, the threshold fix value may be 50%. Using the fix value from the previous example, the 55% fix value is determined to be greater than the 50% threshold. If the fix value is greater than or equal to the threshold fix value, the applied fix method may be maintained, but may be adjusted, or repaired, based on the results of the initial fix method. Because the fix method may be somewhat effective, it may be adjusted instead of rolled back to help resolve the one or more resource problems.

If it is determined, in operation 170, that the one or more resource problems are resolved, method 100 may include operation 180 to send a warning message to a user. In some embodiments, even though the one or more resource problems may be resolved, and the actual root cause may be fixed/eliminated, a warning message may be sent to a user (e.g., via a user interface) to warn a user of the actual root cause and/or the resource problems. The warning may also include an indication that the issues have been resolved. In some embodiments, a user may use the warning message to update code or attempt to eliminate the resource problems in future clusters.

Referring to FIG. 2, a flowchart of a method 200 for predicting a root cause of the resource problems is depicted, according to some embodiments. In some embodiments, the method 200 is implemented as a computer script or computer program (e.g., computer executable code) to be executed by a server on or connected to a computer system (e.g., computer system 400 (FIG. 4)). In some embodiments, the server is a computer device, such as a computer system/server 402 (FIG. 4). In some embodiments, the method 200 is executed by a node, such as a master node (e.g., master node 310 (FIG. 3)) within a cluster (e.g., cluster 320 (FIG. 3)) and/or a node (e.g., computing nodes 10 (FIG. 5)) within a cloud computing environment (e.g., cloud computing environment 50 (FIG. 5)).

In some embodiments, as discussed herein, determining the actual root cause of the one or more problematic pods (e.g., operation 140 (FIG. 1)) may include predicting the root cause of the one or more resource problems. Method 200 for predicting the root cause of the one or more resource problems includes operation 210 to collect past metrics. The past metrics may be metrics from a first time period. Past metrics may include all metrics corresponding to the pods running on the cluster, applications corresponding to the pods, nodes on the cluster, and/or the cluster. In some embodiments, collecting past metrics includes retrieving one or more application metrics and receiving one or more dependent services metrics. The application metrics may be metrics relating to, or corresponding to, the application. An application may depend on one or more dependent services, and the dependent services metrics may be the metrics relating to the dependent services. For example, an application (e.g., a cloud service) may depend on an Identity and Access Management (IAM) service, an engine manager, ETCD, RabbitMQ™ Spark, Cloudant®, etc. In this example, the dependent services metrics may include dependent service uptime, API response code, response time, SSL certificate validity, etc.

In some embodiments, past metrics may include metrics (from a first time period) from required resources (i.e., resources required for the cluster, pods on the cluster, etc.). For example, the past metrics may include attributes such as total memory, total disk space, network IO speed, memory usage, CPU usage, response time for API calls, version check, etc., and data relating to these attributes. In some embodiments, past metrics may also include past predicted root causes and actual root causes. The actual root causes may include data regarding whether alerts were raised, whether the issue was solved manually, what the manual solve was, whether the issue was solved automatically (i.e., a fix method exists), what the fix method was, or any other records from a database (e.g., a root cause analysis (RCA) database). In some embodiments, past metrics are collected from multiple sources (e.g., a logstore, App runtime, RCA database, etc.).

Method 200 includes operation 220 to build a machine learning algorithm. The machine learning algorithm may be based on the past metrics, in some embodiments. In other words, the past metrics may be used to construct a machine learning algorithm for predicting a root cause, or root causes, for various resource problems.

Method 200 includes operation 230 to collect current metrics. In some embodiments, the current metrics are metrics from a current time period. The current time period may be a time period subsequent to, or after, the first time period. In some embodiments, the current metrics may be metrics the same as, or similar to, the past metrics, but are from the current time period. For example, past metrics may include total memory, total disk space, network IO speed, memory usage, CPU usage, response time for API calls, version check, etc. from an earlier time period, and current metrics may include the total memory, total disk space, network IO speed, memory usage, CPU usage, response time for API calls, version check, etc. at the current time period.

Method 200 includes operation 240 to train the machine learning algorithm. Once the machine learning algorithm has been built, the machine learning algorithm may be consistently trained using more and more data as it is gathered. For instance, the machine learning algorithm may be trained based on, or using, the past metrics and the current metrics. In some embodiments, the machine learning may have been built and then subsequently trained using past metrics, and then current metrics may be inputted into the machine learning algorithm to further train the model. In some embodiments, training the machine learning algorithm includes building a training set (e.g., using at least the past metrics). Building the training set may include maintaining a data structure that maps the actual root cause, the predicted root cause, and one or more training set files. The data structure may correspond to past actual root causes, past predicted root causes, and their corresponding training set files, in some embodiments.

For example, the machine learning algorithm may be built and trained using the following attribute tuple:

<Node1_Pod1_METRIC1, Node1_Pod1_METRIC2, . . . , Node1_Pod1_METRICN, Node1_Pod2_METRIC1, Node1_Pod2_METRIC2, . . . Node1_Pod2_MetricN, Node2_Pod1_Metric1, Node2_Pod2_Metric2 etc, . . . Node2_Podm_Metric1, . . . Noden_Podm_MetricN>

<n1_p1_total_mem, n1_p1_total_disk, n1_p1_network_speed, n1_p2_network_io, n1_p1_app_response_time, n1_p1_api_calls_response_time, n1_p1_mem_usage, n1_p1_cpu_usage, . . . n1_p1_metricn,

n1_p2_total_mem, n1_p2_total_disk, n1_p2_network_speed, n1_p2_network_io, n1_p2_app_response_time, n1_p2_api_calls_response_time, n1_p2_mem_usage, n1_p2_cpu_usage, . . . n1_p2_metricn>

In this example attribute tuple, various error types may be encoded (e.g., version check failed—1, OutOfMemory—2, StackOverflow—3, etc. The result for the example attribute tuple may be [ENCODED_ERROR_TYPE] and the [ENCODED_ERROR_TYPE] may then be marked with the corresponding encoded value.

Method 200 includes operation 250 to predict a root cause of the one or more resource problems. The root cause may be predicted based on the past metrics and the current metrics. In some embodiments, the machine learning algorithm is used to predict the root cause. More specifically, in some embodiments, the current metrics may be inputted into the machine learning algorithm, and using the algorithm (e.g., trained by at least the past metrics), the predicted root cause may be outputted. Continuing the above example, once the current metrics are inputted into the example attribute tuple, the result, or output, may include an encoded value that corresponds to an error type/cause or a predicted root cause.

Method 200 includes operation 260 to determine an actual root cause. In some embodiments, the actual root cause is determined by analyzing data collected from multiple data sources, including logs (using log analysis), the RCA database, and investigation of the resources and the resource problem. The analyzing may include determining whether there are any exceptions, repetitive log messages, patterns, etc. Based on the analysis, an actual root cause of the problematic pods and/or the one or more resource problems may be determined.

Method 200 includes operation 270 to determine whether the actual root cause is different than the predicted root cause(s). Determining whether the actual root cause is different than the predicted root cause may include comparing the actual root cause to the predicted root cause. In some embodiments, determining whether the actual root cause is different than the predicted root cause(s) includes operation 260 to determine an actual root cause.

If it is determined, in operation 270, that the actual root cause is different than the predicted root cause(s), method 200 includes operation 280 to retrain the machine learning algorithm. The machine learning algorithm may be retrained with, or using, the actual root cause. In some embodiments, retraining the machine learning algorithm includes tuning the algorithm with positive and/or negative feedback based on the comparison. If the actual root cause is different than the determined root cause, then the machine learning model may not be the most accurate model, and the model may be retrained to help increase the accuracy of the model/machine learning algorithm.

If it is determined, in operation 270, that the actual root cause is not different than the predicted root cause(s) (i.e., the actual root cause is the same as the predicted root cause(s)), method 200 includes operation 275 to add the corresponding metrics to the machine learning algorithm. Even though the machine learning algorithm correctly predicted the root cause, the corresponding metrics (e.g., along with the predicted root cause and actual root cause) may still be added to the machine learning algorithm as additional data to help strengthen the algorithm. This may also increase the accuracy of the machine learning algorithm and may help the algorithm correctly predict future root causes.

Referring to FIG. 3, a schematic diagram of an example cluster environment 300 is depicted, according to some embodiments. In some embodiments, cluster environment 300 includes a cluster 320 of nodes. The cluster 320 may include worker nodes 301, 303, 305, 307, 308, and 309. Cluster 320 may also include a master node 310.

As illustrated, each worker nodes 301, 303, 305, 307, 308, and 309 each run one or more pods. In cluster 320, node 301 runs pod 330 and pod 340, node 303 runs pod 325, node 305 runs pod 325 and pod 340, node 307 runs pod 330 and pod 335, node 308 runs pod 330, and node 309 runs pod 335. In some embodiments, each pod 325, 330, 335, and 340 includes one or more containers. In some embodiments, each pod 325, 330, 335, and 340 runs an instance of an application, and the one or more containers correspond to an instance of the application.

In some embodiments, pod 330 may be determined to be a problematic pod. The resource problems caused by problematic pod 330 may affect node 301, node 307, and node 308. Method 100 may be used to help resolve the resource problems and fix the problematic pod 330, so that nodes 301, 307, and 308 can properly perform operations and run their pods.

Referring to FIG. 4, computer system 400 is a computer system/server 402 is shown in the form of a general-purpose computing device, according to some embodiments. In some embodiments, computer system/server 402 is located on the linking device. In some embodiments, computer system 402 is connected to the linking device. The components of computer system/server 402 may include, but are not limited to, one or more processors or processing units 410, a system memory 460, and a bus 415 that couples various system components including system memory 460 to processor 410.

Bus 415 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 402 typically includes a variety of computer system readable media. Such media may be any available media that is accessible by computer system/server 402, and it includes both volatile and non-volatile media, removable and non-removable media.

System memory 460 can include computer system readable media in the form of volatile memory, such as random-access memory (RAM) 462 and/or cache memory 464. Computer system/server 402 may further include other removable/non-removable, volatile/non-volatile computer system storage media. By way of example only, storage system 465 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 415 by one or more data media interfaces. As will be further depicted and described below, memory 460 may include at least one program product having a set (e.g., at least one) of program modules that are configured to carry out the functions of embodiments of the disclosure.

Program/utility 468, having a set (at least one) of program modules 469, may be stored in memory 460 by way of example, and not limitation, as well as an operating system, one or more application programs, other program modules, and program data. Each of the operating system, one or more application programs, other program modules, and program data or some combination thereof, may include an implementation of a networking environment. Program modules 469 generally carry out the functions and/or methodologies of embodiments of the invention as described herein.

Computer system/server 402 may also communicate with one or more external devices 440 such as a keyboard, a pointing device, a display 430, etc.; one or more devices that enable a user to interact with computer system/server 402; and/or any devices (e.g., network card, modem, etc.) that enable computer system/server 402 to communicate with one or more other computing devices. Such communication can occur via Input/Output (I/O) interfaces 420. Still yet, computer system/server 402 can communicate with one or more networks such as a local area network (LAN), a general wide area network (WAN), and/or a public network (e.g., the Internet) via network adapter 450. As depicted, network adapter 450 communicates with the other components of computer system/server 402 via bus 415. It should be understood that although not shown, other hardware and/or software components could be used in conjunction with computer system/server 402. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

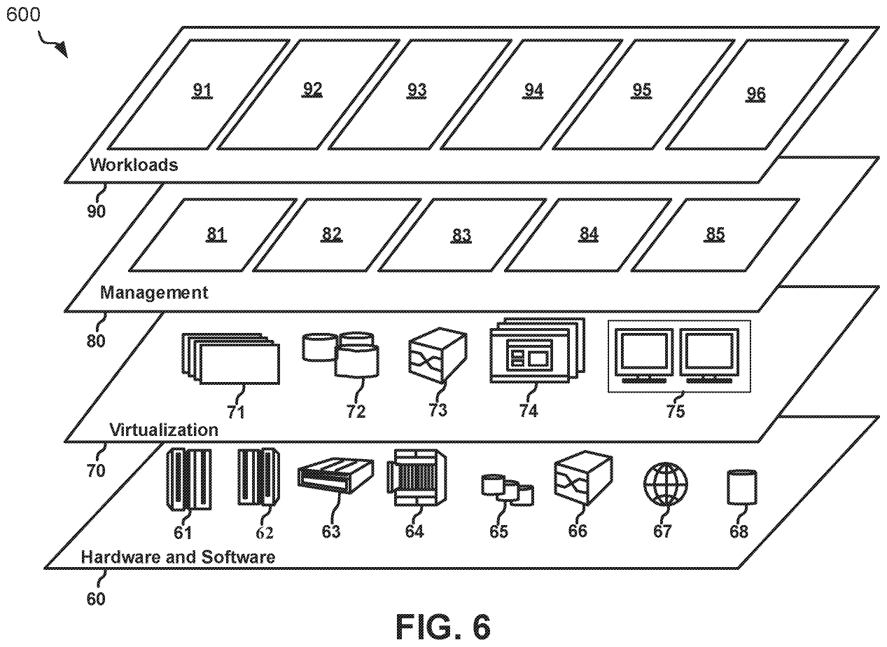

Referring now to FIG. 5, illustrative cloud computing environment 50 is depicted, according to some embodiments. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers 600 provided by cloud computing environment 50 (FIG. 5) is shown, according to some embodiments. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components.

Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below.

Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and root cause analysis 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electronic signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object orientated program language such as Smalltalk, C++, or the like, and procedural programming languages, such as the “C” programming language or similar programming languages. The computer readable program instructions may execute entirely one the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to some embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
identifying one or more resource problems within a cluster;
identifying one or more problematic pods that have the one or more resource problems;
analyzing the one or more resource problems;
determining an actual root cause of the one or more problematic pods based on the analyzing, wherein determining the actual root cause comprises:
analyzing data collected from multiple data sources, wherein the multiple data sources comprise at least one of: logs, an RCA database, and investigation of resources;
determining a fix method for the actual root cause; and
applying the fix method to the one or more problematic pods.

2. The method of claim 1, wherein identifying the one or more problematic pods comprises flagging the one or more problematic pods for a user.

3. The method of claim 1, wherein the analyzing the one or more resource problems comprises:
analyzing one or more resources used for one or more pods within the cluster; and
identifying one or more metrics problems for at least one of the one or more resources.

4. The method of claim 1, wherein determining the actual root cause of the one or more problematic pods comprises predicting the root cause of the one or more resource problems.

5. The method of claim 4, wherein predicting the root cause comprises:
collecting past metrics, wherein the past metrics are metrics from a first time period;
building a machine learning algorithm based on the past metrics;
collecting current metrics, wherein the current metrics are metrics from a current time period, the current time period subsequent to the first time period;
training the machine learning algorithm based on the past metrics and the current metrics; and
predicting the root cause based on the past metrics and the current metrics.

6. The method of claim 5, further comprising:
determining that the actual root cause is different from the one or more predicted root causes; and
in response to determining that the actual root cause is different from the one or more predicted root causes, retraining the machine learning algorithm model with the actual root cause.

7. The method of claim 5, further comprising:
determining that the actual root cause is the same as the one or more predicted root causes; and
in response to determining that the actual root cause is the same as the one or more predicted root causes, adding the one or more predicted root causes to the machine learning algorithm.

8. The method of claim 5, wherein collecting the past metrics comprises:
retrieving one or more application metrics; and
receiving one or more dependent services metrics.

9. The method of claim 5, wherein training the machine learning algorithm based on the past metrics and the current metrics comprises building a training set.

10. The method of claim 9, wherein building the training set comprises maintaining a data structure that maps the actual root cause, the predicted root cause, and one or more training set files.

11. The method of claim 1, further comprising:
transmitting results of the determining the actual root cause to a user.

12. A system having one or more computer processors, the system configured to:
identify one or more resource problems within a cluster;
identify one or more problematic pods having the one or more resource problems;
analyze the one or more resource problems;
determine an actual root cause of the one or more problematic pods based on the analyzing, wherein determining the actual root cause comprises:
analyze data collected from multiple data sources, wherein the multiple data sources comprise at least one of: logs, an RCA database, and investigation of resources; determine a fix method for the actual root cause; and
apply the fix method to the one or more problematic pods.

13. The system of claim 12, wherein the analyzing the one or more resource problems comprises:
analyzing one or more resources used for one or more pods within the cluster; and
identifying one or more metrics problems for at least one of the one or more resources.

14. The system of claim 12, wherein determining the actual root cause of the one or more problematic pods comprises predicting the root cause of the one or more resource problems.

15. The system of claim 14, wherein predicting the root cause comprises:
collecting past metrics, wherein the past metrics are metrics from a first time period;
building a machine learning algorithm based on the past metrics;
collecting current metrics, wherein the current metrics are metrics from a current time period, the current time period subsequent to the first time period;
training the machine learning algorithm based on the past metrics and the current metrics; and
predicting the root cause based on the past metrics and the current metrics.

16. The system of claim 14, further comprising:
determining that the actual root cause is different from the one or more predicted root causes; and
in response to determining that the actual root cause is different from the one or more predicted root causes, retraining the machine learning algorithm model with the actual root cause.

17. A computer program product comprising a computer readable storage medium having program instructions embodied therewith, the program instructions executable by a server to cause the server to perform a method, the method comprising:
identifying one or more resource problems within a cluster;
identifying one or more problematic pods having the one or more resource problems;
analyzing the one or more resource problems;
determining an actual root cause of the one or more problematic pods based on the analyzing, wherein determining the actual root cause comprises:
analyzing data collected from multiple data sources, wherein the multiple data sources comprise at least one of: logs, an RCA database, and investigation of resources;
determining a fix method for the actual root cause; and
applying the fix method to the one or more problematic pods.

18. The computer program product of claim 17, wherein the analyzing the one or more resource problems comprises:
analyzing one or more resources used for one or more pods within the cluster; and
identifying one or more metrics problems for at least one of the one or more resources.

19. The computer program product of claim 17, wherein determining the actual root cause of the one or more problematic pods comprises predicting the root cause of the one or more resource problems.

20. The computer program product of claim 19, wherein predicting the root cause comprises:
collecting past metrics, wherein the past metrics are metrics from a first time period;
building a machine learning algorithm based on the past metrics;
collecting current metrics, wherein the current metrics are metrics from a current time period, the current time period subsequent to the first time period;
training the machine learning algorithm based on the past metrics and the current metrics; and
predicting the root cause based on the past metrics and the current metrics.
